(19) United States
(12) Patent Application Publication
(10) Pub. No.: US 2013/0255953 A1
(43) Pub. Date: Oct. 3, 2013

(54) METHOD AND APPARATUS FOR PREPARING FRACTURING FLUIDS

(71) Applicant: SYNOIL FLUIDS HOLDINGS INC., Calgary (CA)

(72) Inventor: Robin Tudor, Black Diamond, CA (US)

(73) Assignee: SynOil Fluids Holdings Inc., Calgary (CA)

(21) Appl. No.: 13/803,911

(22) Filed: Mar. 14, 2013

(30) Foreign Application Priority Data
Mar. 30, 2012 (CA) 2773019

(51) Int. Cl. C09K 8/62; E21B 43/26

(52) U.S. Cl. CPC C09K 8/62; E21B 43/26
USPC 166/308.1; 507/203; 507/269; 507/200; 366/184; 366/137

(57) ABSTRACT

A method and system are provided for preparing a fracturing fluid for a fracture treatment in a subterranean formation using different types of fluids. A first mixture, formed with a consistent quality fluid and proppant, is combined with a second mixture, formed with an inconsistent quality fluid, to create a combined fracturing fluid. Each of the first and second mixtures may be pressurized and combined for use in one or more stages of a fracture treatment. The consistent quality fluid may comprise a new or high quality fluid and the inconsistent quality fluid may comprise a low quality fluid, such as fluid recovered or recycled from a previous fracturing treatment. Chemicals may be added to one or both mixtures. Quality measurements may be obtained for the second mixture. Independent monitoring and control of system allow for the preparation of a fracturing fluid with predetermined qualities.

### FIELD OF TECHNOLOGY

The present disclosure relates to a method of fracturing a subterranean formation using a pressurized fluid containing solid particulates and chemicals and a system for preparing a fracturing fluid. More specifically, the present disclosure relates to a method and system for fracturing a subterranean formation wherein two streams of fluids are used and wherein quality control of the fluids is enabled.

### BACKGROUND

The use of a pressurized particulate fluid for fracturing a subterranean formation is known in the art. Generally, fracturing is performed by injecting the fluid into the formation at a pressure which is greater than the least geological force (frac pressure) and at rates suitable for propagating the fracture. Generally fluids such as water, methanol, oil, liquefied gases, gases or combinations thereof are used. Chemicals are added to the fluids in order to enhance properties such as friction, viscosity and other necessary characteristics. Proppants such as sand, ceramic spheres or bauxite also are added to the fluids and the mixture is injected into the formation. The proppant allows for a better reservoir recovery. Typically, the fracture fluid(s) are of consistent qualities and pre-lab testing of chemical ratios are used in field operations. The introduction of varying quality fluids with the addition of chemicals at predetermined ratios yields a mixture with varying viscosity and inconsistent frac results.

The use of two streams of fluid in the fracturing process is also known in the art. Such process is disclosed for example in U.S. Pat. No. 3,489,394 of J. M. Stogner et al., U.S. Pat. No. 5,799,734 of Norman et al., U.S. Pat. No. 5,899,272 of Loree, U.S. Pat. No. 5,515,920 of Luk et al., U.S. Pat. No. 5,558,160 of Tudor and US publication No. 2007/0201305 of Heilman et al.

The fracture treatment comprises a number of stages including a volume of fluid to fill the well bore (hole fill); a volume of fluid to create and initiate propagation (pad); a volume of fluid to which proppant is added (proppant slurry), typically with increasing concentrations of proppant; and a volume of fluid to displace the proppant slurry to the bottom of the wellbore (flush). The fracturing fluids are then recovered. The composition and characteristics of the fluid may be varied during the stages of the fracture treatment.

Typically, chemicals and the proppant are added to the base fluid in a blender. The conventional blender has suction manifold, tub and discharge manifold. The suction manifold takes fluid in from storage vessels, the proppant is added through the tub and the content of the blender is discharged through the discharge manifold and fed to high pressure pumps. Chemicals are injected into the fluid as it moves through the blender. The conventional blending system typically discharges an abrasive slurry.

Depending on the nature of the fluid, its handling may require special precautions and equipment. The conventional blender as described above is generally used for fluids such as water, oil and combinations thereof. In the case of gases and liquefied gases, they are either added post blender or to a sealed blender wherein a tub which is also a pressure vessel is used.

In some cases when gases or liquefied gases are used, the treatment process may impose a limit to the amount of proppant used. Canadian patent No. 2,357,973 discloses a method of adding unlimited proppant to the mixture. The method also involves limiting the amount of potentially damaging fluid used.

The selection of the fluid for the fracture treatment process is based on efficiency and economy. Water-based fluids are relatively less expensive. However, they are known to cause residual damage to the formation. Fluids such as liquefied gases are more expensive. The handling of the fluid also may be difficult and costly. In addition, handling of liquefied gases generally presents some difficulties. Canadian patent No. 2,544,027 discloses examples of use of liquefied gases.

The use of oil as fracturing fluid is known in the art and presents some advantages associated with its various properties including molecular make up (carbon number), density, viscosity, flash point, pour point, vapor pressure and aniline point.

Reid Vapor Pressure (RVP) is another element of fluid characteristic to consider in the fluid selection. The addition of proppant to a high RVP fluid, such as a fluid having an RVP above 14 kilopascals, presents a risk of a fire starting due to static or metal sparks. On the other hand, fluids having higher RVP (above 14 kilopascals) are generally significantly less expensive than fluids having lower RVP (below 14 kilopascals). Legislation or regulations in some areas may ban or limit the use of high RVP fluids, such as fluids with an RVP above 14 kilopascals.

### SUMMARY

The present disclosure relates to a method and a system which allow for the preparation of a fracturing fluid for a fracture treatment using different types of fluids. A first mixture is formed with a consistent quality fluid is and a second mixture is formed with an inconsistent quality fluid. The first and second mixtures may be pressurized and then combined to create a combined fracturing fluid. The combined fracturing fluid may be used in one or more stages of a fracture treatment. The first fluid mixture may comprise a consistent high quality, newer or “clean” and more expensive fluid. The second fluid mixture may comprise an inconsistent, low quality fluid, such as fluid recovered or recycled from a previous fracturing treatment. In one embodiment, the first fluid mixture comprises fluids which have not been used in a previous fracturing treatment. Proppant may be added to the first fluid mixture in quantities sufficient to provide for predetermined concentrations of proppant in the combined fracturing fluid. Chemicals may be added to one or both of the first and second mixtures. In one embodiment, quality control is performed for the second mixture and the second mixture is varied to provide for predetermined concentrations of chemicals and characteristics in the combined fracturing fluid.

According to an embodiment of the present disclosure, there is provided a method of preparing a fracturing fluid for use in fracturing a subterranean formation. The method includes forming a first mixture containing a consistent quality fluid and a proppant; forming a second mixture containing an inconsistent quality fluid; and combining the first and second mixtures to create a combined fracturing fluid.

According to an embodiment of the present disclosure there is provided a system for preparing fluids for fracturing a subterranean formation. The system includes a conventional style blender mixing system for preparing a first mixture containing a consistent quality fluid and a proppant and a closed style blender mixing system for preparing a second mixture containing an inconsistent quality fluid. The conventional and closed blenders each have discharge means for discharging the respective first and second mixtures. The system includes means for combining the discharged first and second mixtures to form a combined fracturing fluid. In one embodiment, the system includes pumps for pressurizing the first and second mixtures prior to combining the mixtures.

In one embodiment, the method and system form a first mixture comprised of a consistent quality fluid having a low Reid Vapor Pressure (RVP) and a second mixture comprised of an inconsistent quality fluid having a high RVP, to create a combined fracturing fluid. In some embodiments, the fluid in the first mixture may be a hydrocarbon-based fluid, a gas well condensate, a crude oil, water, a liquid gas such as propane, or liquid CO₂. The fluid in the second mixture may be a hydrocarbon-based fluid, a gas well condensate, a crude oil, water, a liquid gas such as propane, and liquid CO₂.

In additional embodiments, chemicals may be added to one or both of the first and second mixtures. The chemicals used in the first and/or second mixtures may be gellants, activators, breakers, friction reducers, or mixtures thereof. In some embodiments, the method and system of the present disclosure allow for the monitoring and control of the chemical content and quality of the second fluid mixture, to which no proppant is added, and thus control of the chemical content and quality of the combined fracturing fluid. In one embodiment, the monitoring or control or both the monitoring and control are performed using a quality control module which may include a computer. The monitoring or control or both the monitoring and control of the system can be done remotely.

Embodiments of the present disclosure provide a method and system wherein the use of the consistent quality fluid may be limited in quantity and limited in use to one or more stages of a fracture treatment, such as the stage of pressurizing the combined fracturing fluid mixture including proppant into the formation. In some embodiments, the amount of consistent quality fluid used is less than the amount of inconsistent quality fluid used in the fracturing fluid mixture. More specifically, the amount of consistent quality fluid is about 10% to 50% the amount of inconsistent quality fluid. 5. In one embodiment, forming the first mixture includes using a predetermined first concentration of proppant and the method includes varying a volume of the second mixture to create the combined fracturing fluid in order to produce a combined fracturing fluid with a second predetermined concentration of proppant. Additionally, the volume of fluid in the first mixture may be varied.

In other embodiments, the conventional blender mixing system and the closed blender mixing system each operate independently. The conventional blender mixing system has means for allowing addition of the proppant into the blender. The closed blender mixing system is adapted to provide quality control of the second mixture and thus control of the quality of the combined fracturing fluid. In one embodiment, the closed blender mixing system includes a blender and a flowback loop configured to divert a portion of the first mixture from the discharge means to the blender.

### BRIEF DESCRIPTION OF THE DRAWINGS

Embodiments of the present disclosure will be described in greater detail below and will be better understood when read in conjunction with the following drawings:

FIG. 1 is a diagrammatic schematic illustration of an embodiment of the present disclosure;

FIG. 2 is a diagrammatic schematic illustration of an embodiment of the present disclosure; and

FIGS. 3a and 3b are tables which illustrate example mixtures of fluids and proppant according embodiments of the present disclosure.

Like reference numerals are used in the drawings to denote like elements and features. While the invention will be described in conjunction with the illustrated embodiments, it will be understood that it is not intended to limit the invention to such embodiments. On the contrary, it is intended to cover all alternatives, modifications and equivalents that may be included within the spirit and scope of the invention described herein.

### DETAILED DESCRIPTION

The present disclosure provides a method of preparing a fracturing fluid for use in fracturing a subterranean formation. The method includes forming a combined fracturing fluid mixture from at least two mixtures or streams of fluid A, B. The first mixture or stream A includes solid particulate material and consists of a mixture containing a first fluid 2 and a proppant mixed within a conventional style blender 6 in a mixing system 12. In one embodiment, forming of the first mixture A includes adding chemicals to the first fluid 2 in the conventional style blender 6. The second mixture or stream B consists of a mixture containing a second fluid 4 mixed within a closed system style blender 8 in a mixing system 14. In one embodiment, forming of the second mixture B includes adding chemicals to the second fluid 4 in the closed style blender 8.

Each mixture A, B is prepared separately in the distinct mixing systems 12, 14 that will be described further herein. In one embodiment, the two mixtures A, B are delivered to respective high pressure pumps 42, 44 and then combined to create combined fracturing fluid C. In another embodiment, the two mixtures A, B are combined to create combined fracturing fluid C and then the combined fracturing fluid C is delivered to a high pressure pump (not shown) which pressurizes the combined mixture C into the formation to be fractured. The method allows for the control of the chemical contents in the second mixture B and, as a result, control of the chemical contents of the combined mixture C which is pressurized into the formation.

The method includes the use of two different fluid sources characterized as consistent quality fluids 2 and inconsistent quality fluids 4. Consistent quality fluid 2 may include fluids which are new or “clean” and relatively high quality and which have not been used in a previous fracture treatment. Inconsistent quality fluids 4 may include fluids which have been used in and recovered or recycled from previous fracture treatments and are typically of a relatively lower quality. As a result, such inconsistent quality fluids 4 typically have a high Reid Vapor Pressure (RVP). In one embodiment, the consistent quality fluid 2 comprise fluids which have a low RVP, such as an RVP below 14 kilopascals; the inconsistent quality fluid 4 comprise fluids which have a high RVP, such as an RVP greater than or equal to 14 kilopascals. The determination or thresholds for a “high” and “low” RVP fluid may vary and may be set according to legislation or regulations governing the use of fracturing fluids. In one embodiment of the methods disclosed herein, the second mixture B may be comprised of fluids which have not been used in a fracturing treatment although it will be appreciated that in order to reduce the cost of the combined fracturing fluid C, it is desired to limit the use of more expensive, consistent quality or new fluids.

The consistent quality fluid 2 used in the methods according to the present disclosure can be hydrocarbon-based fluids, gas well condensates, crude oils, water, liquid gases such as propane and liquid C_{O2}. The inconsistent quality fluid 4 used in the method according to the present disclosure can be hydrocarbon-based fluids, gas well condensates, crude oils, water, liquid gases such as propane and liquid CO₂.

Where the inconsistent quality fluid 4 comprises a fluid with a high RVP and the consistent quality fluid 2 has a low RVP, such as an RVP below 14 kilopascals, the method includes the addition of proppant only to the consistent quality fluid 2. Proppant is added to the consistent quality fluid 2 in the conventional style blender 6. The proppant may be any suitable particulate material such as sand, ceramic spheres, bauxite or mixtures thereof. Proppant is added in certain stages of the fracture treatment, typically in increasing concentrations (kg/m3) to the downhole combined slurry rate.

In some embodiments, chemicals are added to the first mixture A within the blender 6, or to the second mixture B within the blender 8, or to both first mixture A within the blender 6 and to the second mixture B within the blender 8. The addition of suitable chemicals improves the efficiency and recoverability of the combined fracturing fluid C. Suitable chemicals for adding to the first mixture A can be gellants, activators, breakers, friction reducers or mixtures thereof. Chemicals added to the second mixture B including the inconsistent quality fluid 4 are selected, for example, to increase the viscosity of the second mixture B thereby increasing its efficiency in carrying the combined fracturing fluid C, which includes proppant, into the formation. Suitable chemicals for adding to the second mixture B can be the same as indicated above (activators, breakers, friction reducers or mixtures thereof), but may have different loadings.

The methods of the present disclosure allow for the use of a consistent quality fluid 2 in smaller amounts than the quantity inconsistent quality fluid 4, thereby reducing the costs of a fracture treatment. For example, the method and system 10 described herein allow for the use of inconsistent quality fluid 4 in all stages of treatment except for the stage of introducing the combined fracturing fluid C including the proppant into the formation. The amount of consistent quality fluid 2 used in the process may be less than 50% of the amount of inconsistent quality fluid 4. In one embodiment, the amount of consistent quality fluid 2 is about 10% to 50% of the amount of inconsistent quality fluid 4.

The methods and systems of the present disclosure include monitoring and controlling the rates, concentrations and/or qualities of the various fluids 2, 4; mixtures A, B and proppant 20, thereby allowing control of the quality and properties of the combined fracturing fluid C as described further herein. In one embodiment, the chemical content of the second mixture B and therefore of the combined fracturing fluid C fluid is monitored and controlled using flow back loop technology in the mixing system 14. In another embodiment, the concentration of proppant in the combined fracturing fluid C is achieved by adding a steady concentration of proppant to the mixing system 12 and varying the volume and fluid flow rate of the second mixture B from the mixing system 14.

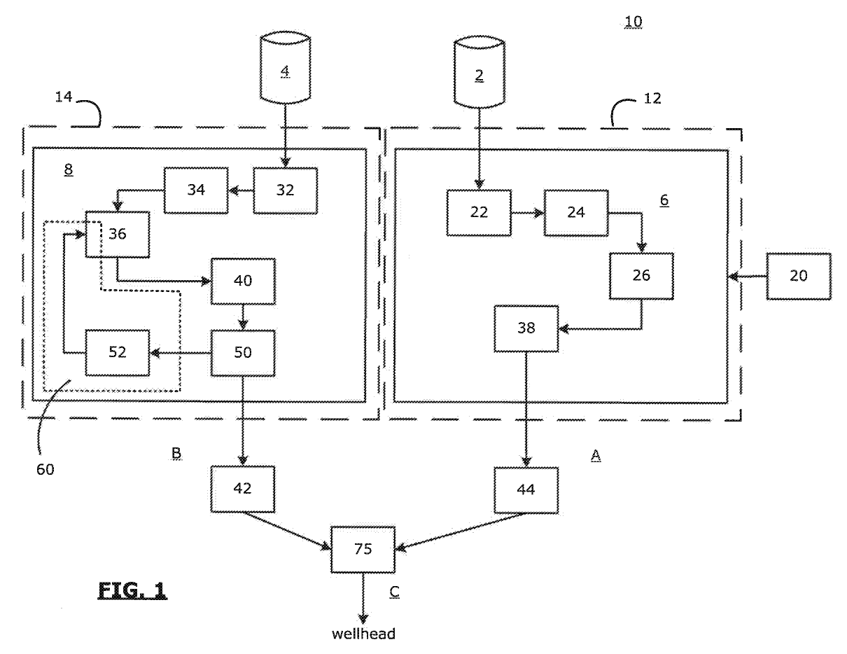

FIG. 1 illustrates an embodiment of a system 10 according to the present disclosure in block diagram form. The system 10 comprises a combination of mixing systems 12, 14. The mixing system 12 includes a conventional style blender 6 and the mixing system 14 includes a closed style blender 8.

The mixing system 12 and the conventional style blender 6 are used to prepare the first mixture A which includes a consistent quality fluid 2 and the proppant 20. The conventional style blender 6 includes a suction manifold 22, a pump 24 and a tub 26. The tub 26 typically refers to a portion of the blender 6 which exposes the fluid to the atmosphere so that proppant 20 can be added. The conventional style blender 6 includes a discharge means 38 for discharging the mixture A, such as a discharge manifold. In some embodiments, the mixing system 12 and conventional style blender 6 include means (not shown) to allow for the addition of chemicals to the low quality fluid 2 to produce the first mixture A.

The mixing system 14 and the closed style blender 8 are used to prepare the second mixture B which includes an inconsistent quality fluid 4. The conventional style blender 8 includes a suction manifold 32 and a pump 34. Chemicals may be added through a chemical injection 40. The contents of the blender 8 are discharged through a discharge means 50 such as a discharge manifold.

The mixtures A, B are discharged to respective frac pumpers 42, 44 for delivery to the wellhead and formation (not shown). The frac pumpers 42, 44 take the discharge from the mixing systems 12, 14 at low pressures, such as 350 kPa, and increase the pressure, typically to around 10 MPa or 75 MPa or greater. The fluids from the frac pumpers are then mixed in high pressure lines such as with a “Y” or “T” connector 75 in the illustration of FIG. 1. The discharge means 38, 50 included in each blender 6, 8; the means for introducing the proppant 20 in the conventional blender 6; and the chemical injection 40 can be any such elements commonly used in the art. Flows are joined with piping.

The system 10 allows for the control of the flow rates, volumes, concentrations and/or qualities of the various fluids 2, 4; chemicals; mixtures A, B and proppant 20 used in preparing the combined fracturing fluid C. The mixing systems 12, 14 are configured to be controlled through one or more computer systems or controllers (not shown). In one embodiment, controllers such as proportional-integral-derivative (PID) controllers are used and programmed to monitor and control the preparation of combined fracturing fluid C and the fracture treatment. In some embodiments, the system 10 includes a computer (not shown) for monitoring and controlling the mixing systems 12, 14. The computer may be situated at a remote location which enables a system operator to monitor and control the system 10 at a safe distance from the wellhead. The frac pumpers 42, 44 also may be controlled through one or more computer systems or controllers.

In one embodiment, a quality control module 52 is included in the mixing system 14 to monitor and control the properties of the second mixture B, including the inconsistent quality fluid 2. The discharge means 50 in the mixing system 14 may be configured to remove or divert a portion of the second mixture B to a flowback loop 60 and the quality control module 52. The flowback loop 60 carries fluid from the discharge means 50 back to the blender 8 such as at a junction 36 between the pump 34 and the chemical injection 40. The flowback loop 60 may include a pump (not shown) to provide for the movement of fluid from the discharge means 50 to the junction 36. In some embodiments, flowmeters (not shown) are provided to measure the flow of the fluid mixture B and the flow of the fluid in the flowback loop 60. In one embodiment, flow-meters are provided at the suction side of the conventional mixing system 12 and at the discharge means 38, 50 of mixing systems 12, 14. Flow rate information from the flowmeters is provided to the quality control module 52 and/or to a computer for monitoring and controlling the system 10.

The quality control module 52 measures the quality of the second mixture B from the conventional style blender 8 as it is discharged. The quality control module 52 may include a controller, means to measure the temperature of the flowback volume, means to heat the flowback volume to the subterranean formation temperature, an inline viscometer, devices to measure density of the flowback volume or combinations of such means and devices. It will be appreciated that the functions and measurements of the quality control module 52 may be implemented using one or more discrete devices in the flowback loop 60 or using a device configured to carry out one or more functions or measurements.

In some embodiments, information from the quality control module 52 is transmitted to a computer for monitoring and controlling the system 10. The computer may be used to receive data from the quality control module 52 and from the mixing systems 12, 14 and to control the mixing systems 12, 14 as described below.

In operation, the systems and methods of the present disclosure allow for a combined fracturing fluid C to be prepared and used in a fracture treatment. In some embodiments, prior to the start of a fracture treatment process, the chemical injection 40 may be preprogrammed with settings for chemical injection based on prior lab analysis of the consistent and inconsistent quality fluids 2, 4, the target formation and the desired outcome of the fracture treatment. Lab testing is used to determine an ideal loading for the proposed fluids to be used and the testing provides a starting point for the use of fluids and chemicals during operation. During a fracture treatment, the quality of the fluid 4 and the second mixture B, and thus the quality of the combined fluid mixture C, may vary due to the use of the inconsistent quality fluid 4. Using data from the quality control module 52, the chemical injection 40 may be adjusted and loadings changed based on actual fluid quality to achieve the desired quality of the fluid mixture B. By monitoring and controlling the quality of the fluid mixture B, the desired quality of the combined fluid mixture C also may be controlled.

It will be appreciated that due to the nature of the flowback loop 60, the effects of changes in chemical addition in the chemical injection 40 are dampened by the rate of fluid flowing in the flowback loop 60. Data from the flowmeters (not shown) may be provided to the quality control module 52 or to the remote computer (not shown) for monitoring and control of the mixing system 14. In some example embodiments, an inline viscometer may be used in the quality control module 52 to measure the viscosity of the second mixture B. Rather than adding chemicals to the second mixture B at predetermined ratios, chemical ratios may be monitored in the second mixture B and the addition of chemicals in the mixing system 14 may be changed in real time through the quality control module 52 to achieve a desired viscosity.

During the fracturing process, proppant 20 is added in certain stages of concentration (kg/m³) to the downhole combined slurry rate, starting at low concentrations and increasing throughout the treatment. In some embodiments, the addition of proppant 20 to the conventional style blender 6 is held constant and the downhole concentration of proppant 20 in the combined fracturing fluid C may be controlled and adjusted by controlling the outputs of the high pressure frac pumpers 42, 44 to create the combined mixture C. In one embodiment, the characteristics of the combined fracture fluid C are controlled by using a constant concentration of proppant 20 in the mixing system 12 and metering the inputs to the mixing systems 12, 14. In one example, a polyemulsion (oil and water) is created by using flowmeters at an input to each mixing system 12, 14, to achieve a proper ratio of the prescribed emulsion in the combined fracturing fluid C.

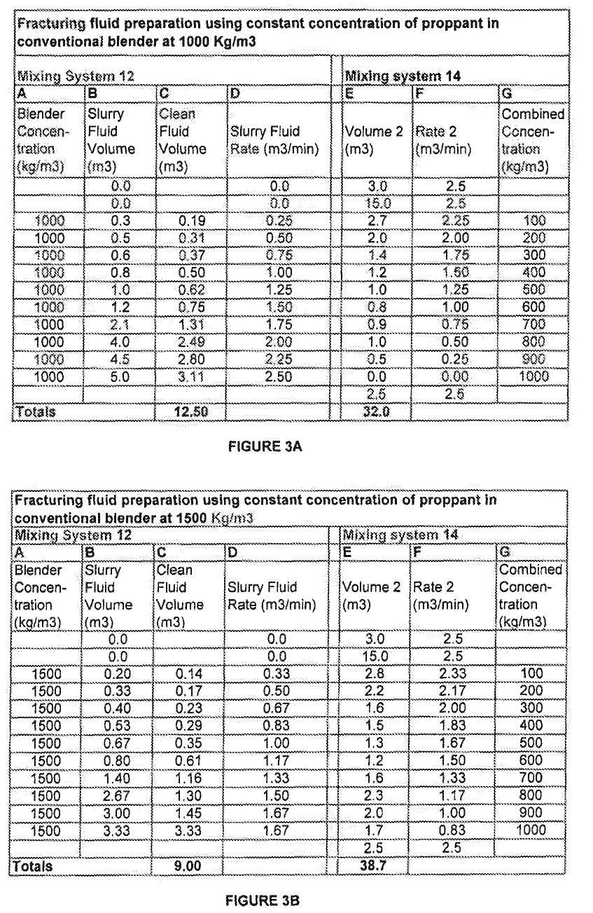

The tables in FIGS. 3A and 3B illustrate example flow rates from the mixing systems 12, 14 and concentrations of proppant 20 in the combined fracturing fluid C when the concentration of proppant 20 in the fluid mixture A in the conventional style blender 6 is held at 1000 kg/m3 (FIG. 3A) and 1500 kg/m3 (FIG. 3B) as indicated in column A of each table. Columns B through D provide volume and rate information for the conventional style blender 6 and mixing system 12. Column B provides the volume of the first mixture A or “slurry fluid” which represents the volume of fluid added to the volume of proppant. Column C provides the volume of fluid 2 added to the blender 6 and column D provides the flow rate of the first mixture A or slurry fluid. Columns E through F provide volume and rate information for the closed style blender 8 and mixing system 14. Column E provides the volumes of low quality fluid 4 and column F provides the flow rate of the second mixture B. The concentration of proppant in the combined fracturing fluid C is provided in column G.

As shown in the examples of FIGS. 3A and 3B, the fluid flow rate of the second mixture B from the mixing system 14 (column F) may be varied to affect and control the final concentration of proppant in the combined fracturing fluid C (column G). By using a first predetermined concentration of proppant 20, and controlled volumes and flow rates of the first mixture A and the second mixture B, a second predetermined or desired concentration of proppant 20 may be achieved in the combined fracturing fluid C. Proppant concentrations may be varied accordingly in the combined fracturing fluid C during stages of the fracture treatment. For example, by creating a first mixture A having a high concentration of proppant and a lower volume of consistent quality fluid 2, and combining the first mixture A with the second mixture B to create the combined fracturing fluid C, the volume of consistent quality fluid, which is typically of a higher quality and cost, required for a fracture treatment may be reduced. In the example of FIG. 3A, a total volume of 12.5 m³ of high quality fluid 2 is used along with a total volume of 32.0 m³ of low quality fluid 4. With a proppant concentration of 1500 kg/m³ as illustrated in FIG. 3B, total volumes are 9.0 m³ and 28.7 m³ for the high quality fluid 2 and low quality fluid 4, respectively. In some embodiments, the concentration of proppant in the first mixture A may be limited by the type of proppant. In an embodiment using a silicate sand proppant, concentrations of 2650 kg/m3in the first mixture A may be achieved.

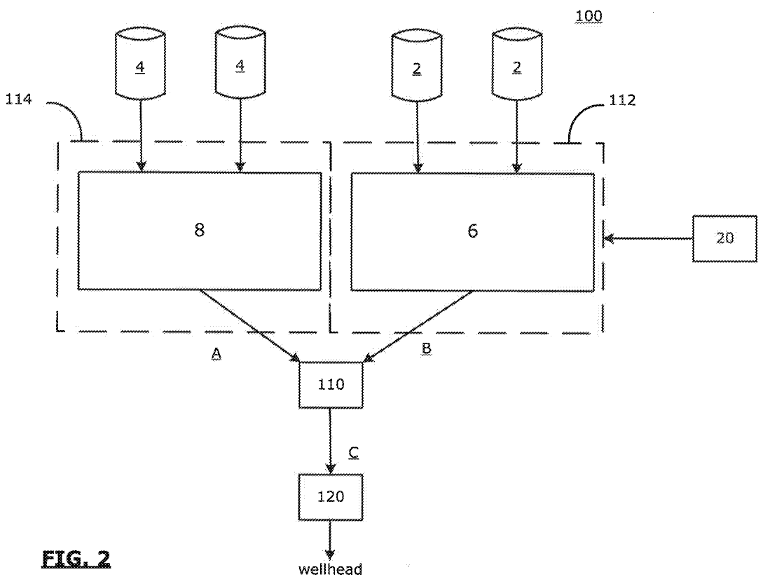

FIG. 2 illustrates an alternative embodiment of a system 100 according to the present disclosure. The system 100 includes mixing systems 112, 114 with a conventional style blender 6 and a closed style blender 8, respectively. The conventional style blender 6 and closed style blender 8 are used for preparing first and second mixtures A, B from respective consistent and inconsistent quality fluids 2, 4. The consistent and inconsistent quality fluids 2, 4 may be stored in one or more tanks 122, 124 for supply to the blenders 6, 8. In the conventional blender 6, a proppant 20 may be added to the mixture A with the consistent quality fluid 2. In the embodiment of FIG. 2, the system 100 comprises means for combining 110 the first and second mixtures A, B when they are discharged from the mixing systems 112, 114 and serving the combined mixture C to a high pressure pump 120. The high pressure pump pressurizes the combined mixture into the formation. The means for combining 110 the mixtures A, B and delivering the combined mixture C to the high pressure pump 120, and the high pressure pump 120 can be any such elements commonly used in the art. In the embodiment of FIG. 2, concentrations of proppant and chemicals in the combined mixture C may be varied by metering the inputs to the individual mixing systems 112, 114.

The mixing system 114 may include a quality control module 52 and a flowback loop 60 as described above. The system 100 also is configured to be controlled through one or more computer systems or controllers (not shown) which can be used to monitor and control of the rates, concentrations and/or qualities of the various fluids 2, 4; chemicals; mixtures A, B and proppant 20.

Thus, it is apparent that there has been provided in accordance with the embodiments of the present disclosure a method and system for preparing a fracturing fluid that fully satisfies the objects, aims and advantages set forth above. While the invention has been described in conjunction with illustrated embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

1. A method of preparing a fracturing fluid for use in fracturing a subterranean formation, comprising:
forming a first mixture containing a consistent quality fluid and a proppant;
forming a second mixture containing an inconsistent quality fluid; and
combining the first and second mixtures to create a combined fracturing fluid.

2. A method as defined in claim 1, wherein the inconsistent quality fluid in the second mixture comprises a recycled fluid.

3. A method as defined in claim 1, wherein the consistent quality fluid in the first mixture has a low Reid Vapor Pressure (RVP) and wherein the inconsistent fluid in the second mixture has a high Reid Vapor Pressure (RVP).

4. A method as defined in claim 3, wherein the low RVP fluid in the first mixture has an RVP below 14 kilopascals and the high RVP fluid in the second mixture has an RVP equal to or greater than 14 kilopascals.

5. A method as defined in claim 1, further comprising:
forming the first mixture using a predetermined first concentration of proppant; and
varying a volume of the second mixture to create the combined fracturing fluid, wherein the combined fracturing fluid has a second concentration of proppant.

6. A method as defined in claim 5 further comprising varying a volume of the first mixture.

7. A method as defined in claim 1, wherein the amount of consistent quality fluid is less than the amount of inconsistent quality fluid.

8. A method as defined in claim 1, wherein the fluid in the first mixture is a hydrocarbon-based fluid, gas well condensate, crude oil, water, liquid gas or a liquid CO₂.

9. A method as defined in claim 1, wherein the fluid in the second mixture is a hydrocarbon-based fluid, gas well condensate, crude oil, water, liquid gas or liquid CO₂.

10. A method as defined in claim 1 wherein forming the first mixture further comprises adding chemicals to the first mixture.

11. A method as defined in claim 1 wherein forming the second mixture further comprises adding chemicals to the second mixture.

12. A method as defined in claim 10, further comprising monitoring chemical contents of the second mixture.

13. A method as defined in claim 10, wherein the chemical is one or more of a gellant, activator, breaker, friction reducer or mixtures thereof.

14. A method as defined in claim 1, wherein the proppant is a sand, ceramic spheres, bauxite or mixtures thereof.

15. A method as defined in claim 1, further comprising:
prior to combining the first and second mixtures to create the combined fracturing fluid, pressurizing each of said first and second mixtures; and
after combining, delivering the combined fracturing fluid into the subterranean formation.

16. A system for preparing fluids for fracturing a subterranean formation, comprising:
a conventional style blender mixing system for preparing a first mixture containing a consistent quality fluid and a proppant;
a closed style blender mixing system for preparing a second mixture containing an inconsistent quality fluid;
the conventional and closed blenders each having discharge means for discharging the respective first and second mixtures; and
means for combining the discharged first and second mixtures to form a combined fracturing fluid.

17. A system as defined in claim 16, further comprising means for delivering the fracturing fluid to a high pressure pump for pressurizing the fracturing fluid into the formation.

18. A system as defined in claim 16, wherein the inconsistent quality fluid comprises a recycled fluid.

19. A system as defined in claim 16, wherein the consistent quality fluid in the first mixture has a low Reid Vapor Pressure (RVP) and wherein the inconsistent quality fluid in the second mixture has a high Reid Vapor Pressure (RVP).

20. A system as defined in claim 16, wherein the conventional blender mixing system and the closed blender mixing system each operate independently.

21. A system as defined in claim 16, wherein the conventional blender mixing system has means for allowing addition of the proppant into the blender.

22. A system as defined in claim 16, wherein the closed blender mixing system includes a quality control module.

23. A system as defined in claim 22 wherein the closed blender mixing system includes a blender and a flowback loop, wherein the flowback loop is configured to divert a portion of the first mixture from the discharge means to the blender.
